(19) United States
(12) Patent Application Publication
(10) Pub. No.: US 2008/0064592 A1
(43) Pub. Date: Mar. 13, 2008

(54) Method for Synthesizing Nano-Sized Titanium Dioxide Particles

(76) Inventors: Insoo Kim, Busan (KR); Gang Hyuk Kim, Busan (KR); Young Jin Choi, Busan (KR); Woo Jin Lee, Busan (KR); Charles E. Smith Jr., Conway, AR (US); Young Jin Kim, Conway, AR (US)

Correspondence Address: WRIGHT, LINDSEY & JENNINGS LLP, 200 WEST CAPITOL AVENUE, SUITE 2300, LITTLE ROCK, AR, 72201-3699, US

(21) Appl. No.: 11/664,711

(22) PCT Filed: Oct. 13, 2005
(86) PCT No.: PCT/US05/36745

§ 371 Date: Apr. 4, 2007

Related U.S. Application Data
(60) Provisional application No. 60/618,781, filed on Oct. 14, 2004.

(51) Int. Cl. C02F 1/42; C01G 23/047

(52) U.S. Cl. 502/337; 106/430; 106/437; 423/598; 423/610; 423/611; 423/612; 502/325; 502/338; 502/339; 502/343; 502/345; 502/347; 502/350

(57) ABSTRACT

A method for synthesizing TiO₂, metal-doped TiO₂, and metal-coated TiO₂ particles of spherical form factor and needle type of which the average particle size is below 150 nm. The method of the invention is to synthesize Ti(OH)₄, metal-doped Ti(OH)4 or metal-coated Ti(OH)4, and react the same by applying a pressure above the saturated vapor pressure at a temperature above 100° C. The pressure is achieved by means of the pressure of the vapor generated during the reaction inside of a closed reactor, by pressure applied from the outside, or a mixture of both. Gases to increase the pressure from outside are preferably inert gases such as Ar and N₂ but are not limited to inert gases.

This application claims the benefit of U.S. Provisional Application No. 60/618,781, filed Oct. 14, 2004 and entitled “Synthesis of Nanosized TiO₂ Powder”.

### TECHNICAL FIELD

The present invention is a method for synthesizing titanium dioxide (TiO₂), metal-doped TiO₂, and metal-coated TiO₂ particles of spherical form factor and needle type of which the average particle size is below 150 nm.

### BACKGROUND ART

Titanium dioxide is a material having diverse fields of application such as paints, plastics, cosmetics, inks, paper, chemical fiber, and optical catalysts. TiO₂ is currently being produced all over the world using a sulfate and chloride process, but there is a problem in applying this process in a field that requires ultra-micro characteristics, since this process produces a relatively large particle diameter (sub-micron level) which does not have a high degree of purity.

As a need for nano-sized TiO₂ increases in diverse fields, a number of researches have been conducted in this field. However, nano-sized TiO₂ is not used extensively due to the high price resulting from the complex production processes now in use.

To solve this problem, it is desirable that a production process be developed so that the production cost of nano-sized TiO₂ can be lowered by increased production efficiency in a simplified production process for nano-sized pure TiO₂, metal-doped TiO₂, and metal-coated TiO₂.

### DISCLOSURE OF THE INVENTION

The present invention is a method for synthesizing TiO₂, metal-doped TiO₂, and metal-coated TiO₂ particles of spherical form factor and needle type of which the average particle size is below 150 nm. The method of the invention is to synthesize Ti(OH)₄, metal-doped Ti(OH)₄ or metal-coated Ti(OH)₄, and then react the same by applying a pressure at or above the saturated vapor pressure at a temperature above 100° C. The pressure is achieved by means of the pressure of water vapor generated during the reaction inside of a closed reactor, by pressure applied from the outside, or a mixture of both. Gases to increase the pressure from outside are preferably inert gases such as Ar and N₂ but are not limited to inert gases.

These and other features, objects and advantages of the present invention will become better understood from a consideration of the following detailed description of the preferred embodiments and appended claims in conjunction with the drawings as described following.

### BRIEF DESCRIPTION OF THE DRAWINGS

FIGS. 1(a)-(b) relate to the TiO₂ powder obtained by the process described in Example 1. FIG. 1(a) is an FESEM microphotograph. FIG. 1(b) is an XRD pattern.

FIGS. 2(a)-(e) relate to the Ag-doped TiO₂ powder obtained by the process described in Example 2. FIG. 2(a) is an FESEM microphotograph. FIG. 2(b) is an XRD pattern. FIG. 2(c) is an XPS survey scan. FIG. 2(d) is an XPS narrow scan for silver peaks. FIG. 2(e) is a chart of UV-visible absorption.

FIGS. 3(a)-(c) relate to the Cr-doped TiO₂ powder obtained by the process described in Example 3. FIG. 3(a) is an FESEM microphotograph. FIG. 3(b) is an XRD pattern. FIG. 3(c) is an EDS analysis.

FIGS. 4(a)-(d) relate to the Ag-coated TiO₂ powder obtained by the process described in Example 4. FIG. 4(a) is an FESEM microphotograph. FIG. 4(b) is an XRD pattern. FIG. 4(c) is an XPS survey scan. FIG. 4(d) is an XPS narrow scan.

### BEST MODE FOR CARRYING OUT THE INVENTION

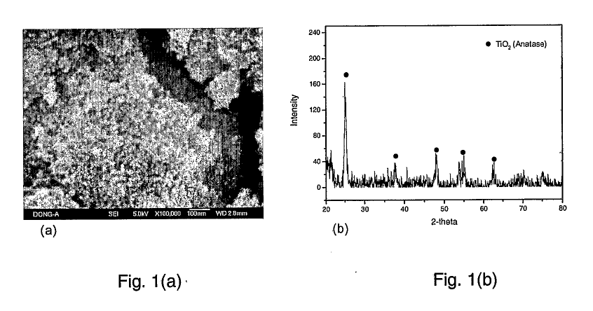

With reference to FIGS. 1-4, the preferred embodiments of the present invention may be described as follows.

The object of the present development is to develop a method that synthesizes a large volume of pure TiO₂, metal-doped TiO₂, and metal-coated TiO₂ having a primary particle size below 150 nm. The method first synthesizes Ti(OH)₄, metal-doped Ti(OH)₄ or metal-coated Ti(OH)₄ in a solution, slurry, cake or dry powder form, and then places one of the foregoing into a closed reactor. In the closed reactor, crystalline TiO₂, metal-doped TiO₂ or metal-coated TiO₂ is synthesized from the Ti(OH)₄, metal-doped Ti(OH)₄ or metal-coated Ti(OH)₄, respectively, by heat treatment at a temperature above 100° C. under a pressure at or above the saturated vapor pressure of water. The pressure in the closed reactor is achieved by water vapor pressure generated inside the reactor, water vapor pressure applied from outside the reactor, gas supplied from outside the reactor, or a mixture thereof.

To synthesize Ti(OH)₄, water soluble titanium ion is educed in the form of Ti(OH)₄ by adding an alkaline substance to a titanium source and then adjusting its pH to 4 or higher. Titanium tetrachloride, titanium trichloride, titaniumoxychloride and titanium sulfate may be used as a titanium source, but the present invention is not limited to these titanium sources and may use any organic or inorganic substance or mixtures that can dissolve in water and form titanium ions or titanium ion complexes. NaOH, KOH, and NH₄OH may be used as the alkaline substance, but the present invention is not so limited and may use any alkaline substance that can dissolve in water and increase the pH of the solution.

Educed Ti(OH)₄ undergoes several water cleaning processes using a centrifuge and ultrafilter system to remove impure ions residing therein. Water washed Ti(OH)₄ can be obtained in the form of a solution, slurry, cake or dry powder through a concentration and drying process.

Metal doped Ti(OH)₄ is obtained by puffing one or more metal salts into the water-soluble titanium source. The water-soluble metal ion and the titanium ion are co-precipitated by adding the alkaline substance to the solution in which the titanium and metal are dissolved, and then adjusting the pH of the solution to 4 or higher as described above. As described above, the present invention may use, but is not limited to, titanium tetrachloride, titanium trichloride, titaniumoxychloride or titanium sulfate as a titanium source. Likewise, the present invention may use, but it is not limited to NaOH, KOH, and NH₄OH as the alkaline substance. Water soluble salts of Ag, Zn, Cu, V, Cr, Mn, Fe, Co, Ni, Ge, Mo, Ru, Rh, Pd, Sn, W, Pt, Au, Sr, Al, and Si can be used as the source of the metal ion, although the present invention is not limited thereto and all water soluble metal salts may be used as well. Co-precipitated metal-doped Ti(OH)₄ undergoes several water cleaning processes by using a centrifuge and ultrafilter system to remove impure ions residing therein. As a result of assay for water-washed metal-doped Ti(OH)₄ educts, added metal ingredients were detected, which are believed to co-precipitate together with the Ti ion upon addition of an alkaline substance. Water-washed metal-doped Ti(OH)₄ can be obtained in the form of a solution, slurry, cake, and dry powder through the concentration and drying process described above.

To synthesize metal-coated Ti(OH)₄, water soluble titanium ion is educed in the form of Ti(OH)₄ by adding an alkaline substance to a titanium source and then adjusting its pH to 4 or higher. Titanium tetrachloride, titanium trichloride, titaniumoxychloride or titanium sulfate may be used as the titanium source, but the present invention is not limited thereto and may use all organic and inorganic substances or mixtures that can dissolve in water and form titanium ions or titanium complex ions. NaOH, KOH, and NH₄OH can be used as the alkaline substance, but the present invention is not limited thereto and may use all alkaline substances that can dissolve in water and increase the pH of the solution. After educed Ti(OH)₄ undergoes a water cleaning process of 3-4 times and impurities are completely removed, it is dispersed by means of a ultrasonic treatment in distilled water.

After one or more metal salts of a desired amount are added into the dispersed Ti(OH)₄, it is aged for a time that exceeds 5 minutes. It is preferable that the aging be at a temperature below 100° C. Water soluble salts of Ag, Zn, Cu, V, Cr, Mn, Fe, Co, Ni, Ge, Mo, Ru, Rh, Pd, Sn, W, Pt, Au, Sr, Al, and Si may be used as the metal salts in the present invention, but the practice of the present invention is not limited thereto and may use all water soluble metal salts. After aging, the educts undergo a water cleaning process of 2-3 times to remove impure ions, obtaining metal-coated Ti(OH)₄ thereby. As a result of assay for water washed, metal coated Ti(OH)₄ educts, added metal ingredients were detected, and it is believed that added metal ions are adsorbed to the surface of the Ti(OH)₄ particles although the exact mechanism by which the metal is added to the Ti(OH)₄ particles is not known to the present inventors. Water-washed, metal-coated Ti(OH)₄ can be obtained in the form of a solution, slurry, cake, or dry powder through a concentration and drying process.

As already mentioned, water-washed Ti(OH)₄, metal-doped Ti(OH)₄, and metal-coated Ti(OH)₄ can exist in the form of a solution, slurry, cake or dry powder according to its moisture content and concentration degree. Considering the need for production efficiency, it is desirable to opt for the form of cake or dry powder having high titanium content. But if the water content contained in the educts is too low or even non-existent during the reaction inside the closed reactor, there are problems such as: (1) the reaction for phase transformation when condensed water or water vapor is not present requires a higher temperature than that required when condensed water or water vapor is present inside the reactor, for example if the reaction temperature with water present is 160° C., the reaction temperature without water present should be over 300° C., a difference of more than 100° C., (2) a color change at the surface of the TiO₂ (generally yellow) can be observed, and (3) it is difficult to obtain micro-fine particles in the crushing process due to excessive rigidity of the particles formed.

Some condensed water is absolutely necessary in the reactor to decrease the reaction temperature to ensure that amorphous TiO₂ becomes anatase TiO₂ and to prevent the yellow color change mentioned above. Typically, even with a dried powder, a small amount of water is produced in the reactor by the reaction Ti(OH)₄═TiO₂+2H₂O. By maintaining a pressure in the reactor at or above the saturated vapor pressure of water, an amount of condensed water in the reactor is assured. As discussed previously, the pressure may be supplied by water vapor from the reaction, water vapor introduced into the reactor from outside, a gas such as an inert gas, or a combination of the preceding.

In order to prove that the above-mentioned problems are closely related to the moisture content in the educts (Ti(OH)₄, metal-doped Ti(OH)₄, and metal-coated Ti(OH)₄), we conducted the following experiment.

Cake or dried Ti(OH)₄ powder was put into the closed reactor, and then it was reacted for 2 hours under the conditions of saturated vapor pressure and 160° C. The phase obtained thereof was crystalline TiO₂. On the contrary, when cake or dried Ti(OH)₄ powder was put into an open reactor, and reacted for 3 hours under the conditions of atmospheric pressure and 300° C., the phase obtained thereof was a non-crystalline phase, manifesting a yellow color. From these results, we believe that the pressure applied to the reactor and water vapor or condensed water inside the reactor was the source for the change of temperature and color associated with the phase change from non-crystalline to crystalline forms.

To look into the effect of pressure, cake or dried Ti(OH)₄ was put into a closed reactor, and then it was reacted for 2 hours at 160° C. Then the pressure experiments were conducted respectively against saturated vapor pressure, 2.07*10⁶ N/m², and 3.45*10⁶ N/m² pressures by adding argon gas from outside the reactor. All three specimens manifested the same anatase crystalline phase. From this result, it was verified that pressure does not influence or has a negligible effect on the temperature associated with the phase change from non-crystalline Ti(OH)₄ to crystalline TiO₂.

To look into the effect of condensed water or water vapor, cake or dried Ti(OH)₄ was put into a closed reactor under the condition of removed humidity, and then it was reacted for 2 hours at 160° C. by adding nitrogen having a pressure corresponding to the saturated vapor pressure. The phase obtained thereby was non-crystalline and it manifested a yellow color.

From these experiments, it is believed that it is desirable to minimize the loss of water vapor during the reaction in order to prevent the increased temperature associated with the phase change from non-crystalline to crystalline, the color change, and the formation of TiO₂ of rigid form in the cake or dried powder. The present invention was completed by means of inducing the reaction inside the closed reactor by supplying from the outside two or more mixed gases composed of water vapor, gas, or water vapor and gas. The present invention has been described with respect to the production of TiO₂ as an example, but the described process can be also applied to produce metal-doped TiO₂ and metal-coated TiO₂ in the same way as shown in the following examples.

### EXAMPLE 1

440 cc of Titanium oxychloride ((dissolved TiCl₄ in H₂O by approximately 50 wt %)) was put into distilled water of 1,560 cc. The final pH was adjusted to 6.5 by adding ammonia water after titanium oxychloride was completely dissolved. Then impure ions were removed by washing the educts with water. The Ti(OH)₄ with impure ions removed was then concentrated using a filtering system and it was dried for 12 hours at 60° C. After dried specimen was put into the closed reactor and the pressure of the closed reactor was adjusted to 0.83*10⁶ N/m² with argon gas, it was reacted for 2 hours at 160° C. After ammonia gas generated in the inside thereof was removed by undergoing repetitive processes of water supply from the outside to the closed reactor after reaction, and water vapor and gas vented, it was cooled off to a normal temperature. White TiO₂ powder was obtained through this process. The powder had a primary particle size of approximately 10 nm (See FIG. 1(a)), and manifested the crystalline phase of anatase TiO₂ (See FIG. 1(b)).

### EXAMPLE 2

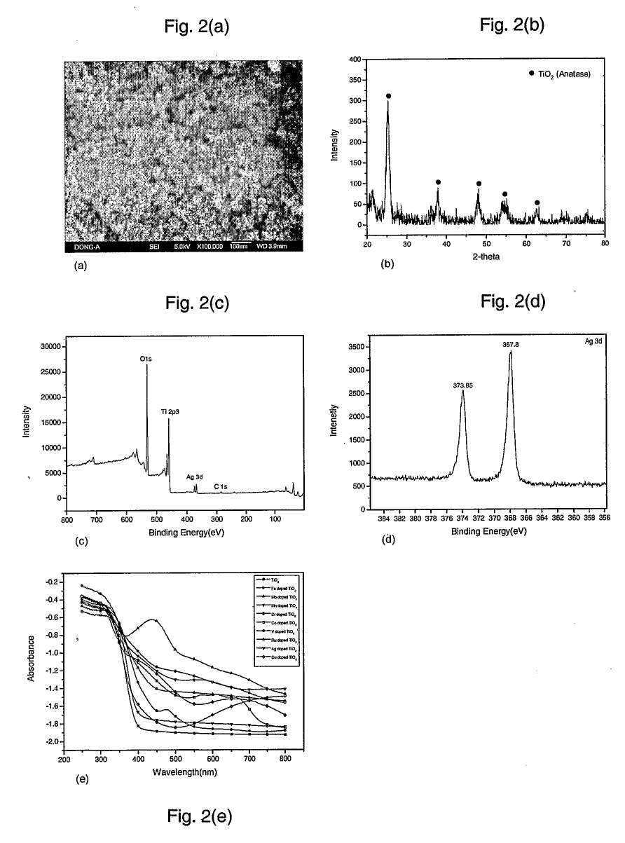

77 cc of titanium oxychloride (dissolved TiCl₄ in H₂O by approximately 50 wt %) was put into 273 cc of distilled water, and 0.22 g of AgNO₃ was added into the solution. After titanium oxychloride and AgNO₃ are completely dissolved, final pH was adjusted to 6.5 by adding about 70 cc of ammonia water. Then impure ions were removed by washing the educts with water. After 1M Ag-doped Ti(OH)₄ was prepared using an ultrafilter, it was put into a closed reactor and then reacted for 2 hours at 160° C. FIGS. 2(a)-(e) show the analysis results for the reacted specimen.

Ag-doped TiO₂ obtained after reaction formed anatase TiO₂ particles having primary particle sizes of around 10 nm (See FIGS. 2(a) and (b)). It is believed that doped Ag exists in the form of pure silver or silver oxide (See FIGS. 2(c) and 2(d)). FIG. 2(e) indicates the UV-visible absorption of TiO₂ doped with various elements. It can be seen that different absorptions are manifested depending upon the element doped.

### EXAMPLE 3

7.7 cc of titanium oxychloride (dissolved TiCl₄ in H₂O by approximately 50 wt %) was put into 342.3 cc of distilled water, and 0.717 g of chromium(III) chloride hexahydrate was added into the solution. After titanium oxychloride and chromium compounds were completely dissolved, final pH level was adjusted to 9 by adding about 10 cc of ammonia water. Then impure ions were removed by washing the educts with water. 0.1M Cr-doped Ti(OH)₄ solution with impure ions removed was put into the closed reactor and then it was reacted for 3 hours at 150° C.

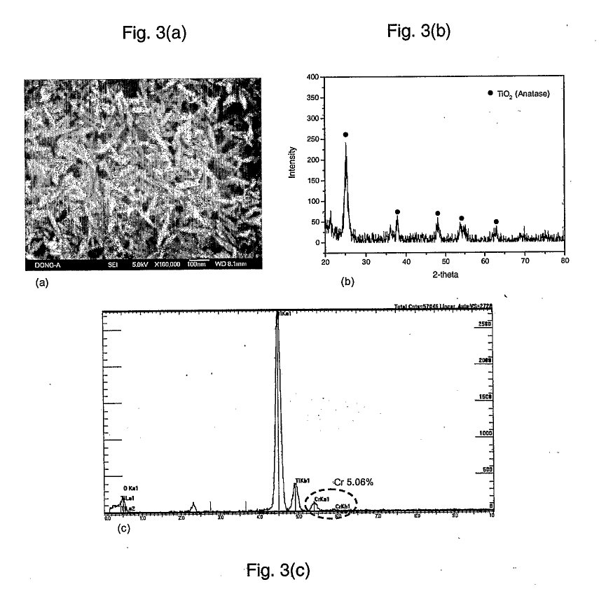

The Cr-doped TiO₂ thus formed manifested anatase TiO₂ of a needle form factor (long axis=˜100 nm, short axis=˜20 nm) (See FIGS. 3(a) and (b)). Through this process, TiO₂ powder doped with Cr of ˜5 wt % was prepared (See FIG. 3(c)).

### EXAMPLE 4

77 cc of titanium oxychloride (dissolved TiCl₄ in H₂O by approximately 50 wt %) was put into 273 cc of distilled water. After titanium oxychloride was completely dissolved, the final pH was adjusted to 6.5 by adding about 70 cc of ammonia water. After impure ions were removed by washing the educts with water, it was dispersed through ultrasonic treatment. After 0.22 g of AgNO₃ was put into the dispersed Ti(OH)₄, it was kept for one hour at a normal temperature. Ag-coated Ti(OH)₄ was obtained by undergoing a water cleaning process of 2-3 times to remove impure ions from the educts after aging. 1M Ag coated Ti(OH)₄ solution was put into a closed reactor and then reacted for 2 hours at 170° C.

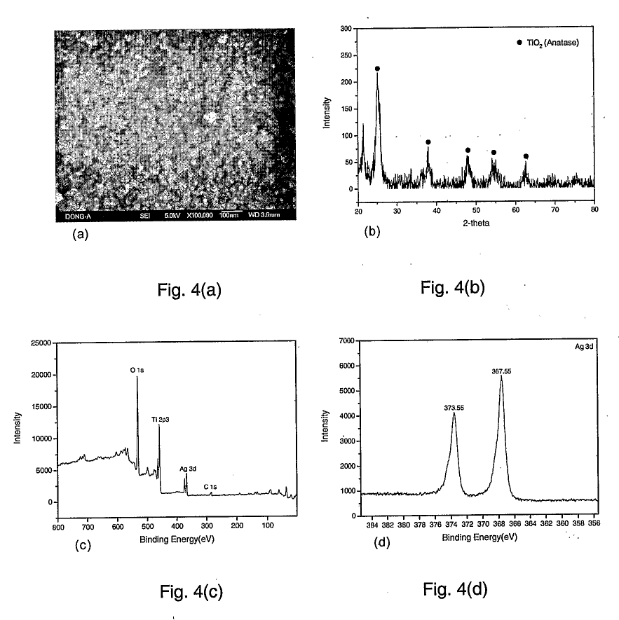

Crystalline phase Ag-coated TiO₂ having a primary particle size of approximately 10 nm was formed (See FIGS. 4(a) and (b)). It was verified that silver exists in the form of pure silver or silver oxide (See FIGS. 4(c) and (d)).

### INDUSTRIAL APPLICABILITY

The present invention has been described with reference to certain preferred and alternative embodiments that are intended to be exemplary only and not limiting to the full scope of the present invention as set forth in the appended claims.

1. A method of synthesizing titanium dioxide (TiO₂) particles, comprising the step of:
reacting Ti(OH)₄ in a closed reaction vessel at a pressure of at least the saturated vapor pressure of water and a temperature above 100° C. to produce particles of TiO₂.

2. The method of claim 1, further comprising the step, before the reacting step, of synthesizing Ti(OH)₄ by adding an alkaline substance to a solution of a water-soluble titanium ions or titanium complex ions and adjusting the pH of the mixture to 4 or higher.

3. The method of claim 2 where said water soluble titanium ion is selected from the group consisting of titanium tetrachloride, titanium trichloride, titaniumoxychloride and titanium sulfate.

4. The method of claim 2 where said alkaline substance is selected from the group consisting of NaOH, KOH and NH₄OH.

5. The method of claim 2 further comprising the step, following the synthesizing of Ti(OH)₄ and before the reacting step, of removing impure ions from said Ti(OH)₄.

6. The method of claim 1 wherein said pressure is supplied by water vapor from inside the reaction vessel, by water vapor from outside the reaction vessel, by gas supplied from outside the reaction vessel, or by a mixture of the preceding.

7. The method of claim 6, where said gas is an inert gas.

8. The method of claim 2, further comprising the step of adding at least one water-soluble metal salt having a metal ion to said solution of a water-soluble titanium ions or titanium complex ions prior to adding said alkaline substance and co-precipitating said metal ion and said titanium ion as metal-doped Ti(OH)₄, whereby said particles of TiO₂ produced by said reacting step are metal-doped TiO₂.

9. The method of claim 8 wherein said water-soluble metal salt is selected from the group consisting of the water-soluble metal salts of Ag, Zn, Cu, V, Cr, Mn, Fe, Co, Ni, Ge, Mo, Ru, Rh, Pd, Sn, W, Pt, Au, Sr, Al, and Si.

10. The method of claim 5 further comprising the step, following the removing of impure ions and before the reacting step, of dispersing said Ti(OH)₄ by ultrasonic treatment in distilled water.

11. The method of claim 10 further comprising the steps of adding at least one water-soluble metal salt to said dispersed Ti(OH)₄ and aging the mixture of metal salt and dispersed Ti(OH)₄ for at least 5 minutes before the reacting step, whereby said particles of TiO₂ produced by said reacting step are metal-coated TiO₂.

12. The method of claim 11 wherein said aging step is at a temperature below 100° C.

13. The method of claim 11 wherein said water-soluble metal salt is selected from the group consisting of the water-soluble metal salts of Ag, Zn, Cu, V, Cr, Mn, Fe, Co, Ni, Ge, Mo, Ru, Rh, Pd, Sn, W, Pt, Au, Sr, Al, and Si.

14. The method of claim 1 wherein said particles of TiO₂ comprise particles whose average size of primary particles is below 150 nm.

15. The method of claim 1 wherein said particles of TiO₂ comprise particles of spherical form factor.

16. The method of claim 1 wherein said particles of TiO₂ comprise particles of needle type.

17. The method of claim 5 further comprising the step of concentrating and drying said Ti(OH)₄.

18. The method of claim 17 wherein said concentrated and dried Ti(OH)₄ is produced in the form of a solution, slurry, cake or dried powder depending upon the degree of concentration of Ti(OH)₄.
